(19) United States
(12) Patent Application Publication
(10) Pub. No.: US 2009/0243362 A1
(43) Pub. Date: Oct. 1, 2009

(54) VEHICLE SEAT ASSEMBLY CAPABLE OF PERFORMING EASY ENTRY WITH FULL MEMORY

(75) Inventor: Stanislaw Andrzej Wieclawski, Hohenkammer (DE)

Correspondence Address: BROOKS KUSHMAN P.C. / LEAR CORPORATION, 1000 TOWN CENTER, TWENTY-SECOND FLOOR, SOUTHFIELD, MI, 48075-1238, US

(73) Assignee: LEAR CORPORATION, Southfield, MI (US)

(21) Appl. No.: 12/372,239

(22) Filed: Feb. 17, 2009

(30) Foreign Application Priority Data
Mar. 28, 2008 (DE) 10 2008 016 203.5

(51) Int. Cl. B60N 2/02

(52) U.S. Cl. 297/366

(57) ABSTRACT

A vehicle seat assembly capable of performing an easy entry function having a seat bottom, a seat back pivotal with respect to the seat bottom, and a recliner mechanism for controlling pivotal motion of the seat back and a recliner mechanism actuator subassembly having a base member, a memory ring having a notch and a memory ring engagement member having a protrusion configured to engage the notch. The memory ring engagement member inhibits rotation of the memory ring when the protrusion is engaged with the notch and permits rotation of the memory ring when the protrusion is disengaged from the notch. The memory ring engagement member retains the recliner mechanism in an unlocked state while the protrusion is disengaged from the notch.

### CROSS-REFERENCE TO RELATED APPLICATIONS

This application claims foreign priority benefits under 35 U.S.C. §119(a)-(d) to DE 10 2008 016 203.5, filed Mar. 28, 2008, which is hereby incorporated by reference in its entirety.

### BACKGROUND OF THE INVENTION

1. Field of the Invention

The field of the invention disclosed herein relates to vehicle seat assemblies adapted to perform an easy entry function and having a memory capability such that, subsequent to actuation of the vehicle seat assembly's easy entry function, the seat back portion of the vehicle seat assembly locks into substantially the same angular orientation with respect to the seat bottom that the seat back occupied immediately prior to actuation of the vehicle seat assembly's easy entry function, regardless of the initial position of the seat back.

2. Background Art

A vehicle seat assembly capable of performing an easy entry function is disclosed herein. Examples of vehicle seat assemblies capable of performing easy entry functions are disclosed in U.S. Pat. Nos. 7,097,250; 6,513,868; 5,899,532; 5,855,349; and 5,100,092; and in U.S. Patent Application Publications 2004/0164600.

### SUMMARY OF THE INVENTION

A vehicle seat assembly capable of performing an easy entry function is disclosed herein. In a first embodiment, the vehicle seat assembly comprises a seat body having a seat bottom, a seat back configured to pivot with respect to the seat bottom about a pivot axis, and a recliner mechanism that is configured to inhibit the seat back from pivoting when the recliner mechanism is locked and to permit the seat back to pivot when the recliner mechanism is unlocked. The vehicle seat assembly also includes a recliner mechanism actuator subassembly that is disposed proximate to the seat body. The recliner mechanism actuator subassembly has a base member that is connected to the seat back and is configured to pivot together with the seat back about the pivot axis. The recliner mechanism actuator subassembly also has a memory ring that has an outer surface and a notch defined in the outer surface. The memory ring is disposed proximate to the base member and is configured to rotate about the pivot axis. The recliner mechanism actuator subassembly also includes a memory ring engagement member that is connected to the seat bottom proximate the memory ring and has a protrusion that is configured to engage the notch. The memory ring engagement member is configured to move between an engaged position wherein the protrusion engages the notch and a disengaged position wherein the protrusion is disengaged from the notch. In this first embodiment, the memory ring engagement member inhibits the memory ring from rotating about the pivot axis when the memory ring engagement member is in the engaged position such that the base member rotates with respect to the memory ring as the base member pivots together with the seat back. The memory ring rotates together with the base member as the seat back pivots when the memory ring engagement member is in the disengaged position. The memory ring engagement member is inhibited from returning to the engaged position until the notch is substantially aligned with the protrusion. The recliner mechanism remains unlocked while the memory ring engagement member is in the disengaged position.

In an implementation of the first embodiment, the memory ring engagement member pivots between the engaged position and the disengaged position.

In another implementation of the first embodiment, the recliner mechanism actuator subassembly further includes a first biasing member that is configured to urge the memory ring and the base member against one another such that friction between the base member and the memory ring causes the memory ring to pivot together with the base member when the seat back pivots while the memory ring engagement member is in the disengaged position. In a variation, the first biasing member may be a spring. In a further variation, the first biasing member may be a plate spring.

In a second embodiment, a vehicle seat assembly capable of performing an easy entry function comprises a seat body having a seat bottom, a seat back that is configured to pivot with respect to the seat bottom about a pivot axis, and a recliner mechanism configured to inhibit the seat back from pivoting when the recliner mechanism is locked and to permit the seat back to pivot when the recliner mechanism is unlocked. The vehicle seat assembly also comprises a recliner mechanism actuator subassembly that is disposed proximate the seat body. The recliner mechanism actuator subassembly has a base member that is connected to the seat back and is configured to pivot together with the seat back about the pivot axis. The recliner mechanism actuator subassembly also has a memory ring that has an outer surface and a notch defined in the outer surface. The memory ring is disposed proximate the base member and is configured to rotate about the pivot axis. The recliner mechanism actuator subassembly also includes a memory ring engagement member that is connected to the seat bottom proximate the memory ring and has a protrusion that is configured to engage the notch. The memory ring engagement member is configured to move between an engaged position wherein the protrusion engages the notch and a disengaged position wherein the protrusion is disengaged from the notch. The recliner mechanism actuator subassembly also includes a recliner mechanism engagement member that is engaged with the recliner mechanism and is configured to move between a closed position and an open position. The recliner mechanism engagement member is configured to move the recliner mechanism from the locked position to the unlocked position when the recliner mechanism engagement member moves from the closed position to the open position. The recliner mechanism moves from the unlocked position to the locked position when the recliner mechanism engagement member moves from the open position to the closed position. In this second embodiment, the memory ring engagement member inhibits the memory ring from rotating about the pivot axis when in the engaged position such that the base member rotates with respect to the memory ring as the base member pivots together with the seat back. The memory ring rotates together with the base member as the seat back pivots when the memory ring engagement member is in the disengaged position. The memory ring engagement member is inhibited from returning to the engaged position until the notch is substantially aligned with the protrusion. The memory ring engagement member is configured to inhibit the recliner mechanism engagement member from moving from the open position to the closed position while the memory ring engagement member is in the disengaged position.

In one implementation of the second embodiment, the recliner mechanism engagement member pivots about the pivot axis between the open position and the closed position.

In another implementation of the second embodiment, the recliner mechanism actuator assembly further comprises a connecting rod having a first end and a second end. The connecting rod is pivotally connected at the first end to the memory ring engagement member and pivotally connected at the second end to the recliner mechanism engagement member. In a variation of this implementation, the recliner mechanism engagement member has a slot extending along a length of the recliner mechanism engagement member. The connecting rod includes the pin disposed with in the slot and configured to slide along the slot. In another variation of this implementation, the connecting rod has an attachment member that is adapted to receive a linkage to facilitate remote actuation of the recliner mechanism actuator subassembly. In another variation, the vehicle seat assembly includes a second biasing member that biases the memory ring engagement member towards the engaged position and a third biasing member that biases the recliner mechanism engagement member towards the closed position. In a further variation, the second and third biasing member are springs. In another variation, the third biasing member is stronger than the second biasing member. In this variation, an actuating force acting on the connecting rod causes the memory ring engagement member to move from the engaged position to the disengaged position before the recliner mechanism engagement member moves to the open position. In a further variation, the third biasing member is sufficiently stronger than the second biasing member such that an actuating force acting on the connecting rod causes the memory ring engagement member to move from the engaged position to the disengaged position before the recliner mechanism engagement member moves from the closed position.

In another implementation of the second embodiment, the memory ring engagement member pivots between the engaged position and the disengaged position.

In another implementation of the second embodiment, the recliner mechanism actuator subassembly further includes a first biasing member that is configured to urge the memory ring and the biasing member against one another such that friction between the base member and the memory ring causes the memory ring to pivot together with the base member when the seat back pivots while the memory ring engagement member is in the disengaged position. In a variation of this implementation, the first biasing member is a spring. In a further variation, the first biasing member is a plate spring.

In a third embodiment of the disclosed invention, a vehicle seat assembly comprises a seat body having a seat bottom, a seat back that is configured to pivot with respect to the seat bottom about a pivot axis, and a recliner mechanism that is configured to inhibit the seat back from pivoting when the recliner mechanism is locked and to permit the seat back to pivot when the recliner mechanism is unlocked. The vehicle seat assembly further comprises a recliner mechanism actuator subassembly that is disposed proximate the seat body. The recliner mechanism actuator subassembly has a base member that is connected to the seat back and that is configured to pivot together with the seat back about the pivot axis. The recliner mechanism actuator subassembly further includes a memory ring having an outer surface and a notch defined in the outer surface. The memory ring is disposed proximate the base member and is configured to rotate about the pivot axis. The recliner mechanism actuator subassembly further includes a memory ring engagement member that is connected to the seat bottom proximate the memory ring and has a protrusion configured to engage the notch. The memory ring engagement member is configured to move between an engaged position wherein the protrusion engages the notch and a disengaged position wherein the protrusion is disengaged from the notch. The recliner mechanism actuator subassembly also has a recliner mechanism engagement member that is engaged with the recliner mechanism and is configured to move between a closed position and an open position. The recliner mechanism engagement member is configured to move the recliner mechanism from the locked position to the unlocked position when the recliner mechanism engagement member moves from the closed position to the open position. The recliner mechanism moves from the unlocked position to the locked position when the recliner mechanism engagement member moves from the open position to the closed position. The recliner mechanism actuator subassembly also has a blocking member that is connected to the memory ring engagement member. The blocking member is configured to move between a blocking position wherein the blocking member inhibits the recliner mechanism engagement member from moving from the open position to the closed position and a non-blocking position wherein the blocking member does not inhibit the recliner mechanism engagement member from moving from the open position to the closed position. The blocking member is biased towards the blocking position. In this third embodiment, the memory ring engagement member inhibits the memory ring from rotating about the pivot axis when the memory ring engagement member is in the engaged position such that the base member rotates with respect to the memory ring as the base member pivots together with the seat back. The memory ring can rotate together with the base member as the seat back pivots when the memory ring engagement member is in the disengaged position. The memory ring engagement member is inhibited from returning to the engaged position until the notch is substantially aligned with the protrusion. The memory ring engagement member is configured to move the blocking member from the blocking position to the non-blocking position when the memory ring engagement member moves from the disengaged position to the engaged position.

In an implementation of the third embodiment, the memory ring engagement member includes a retaining member that is configured to engage the blocking member wherein the retaining member retains the blocking member in the non-blocking position when the memory ring engagement member is in the engaged position. The retaining member permits the blocking member to move to the blocking position when the memory ring engagement member is in the disengaged position.

### BRIEF DESCRIPTION OF THE DRAWINGS

The description herein makes reference to the accompanying drawing wherein like reference numerals refer to like parts through the several views, and in which:

FIG. 1 is a perspective view of an embodiment of the vehicle seat assembly of the present invention;

FIG. 2 is a plan view of a recliner mechanism actuator subassembly of the vehicle seat assembly of FIG. 1;

FIG. 3 is a plan view of various components of the recliner mechanism actuator subassembly of FIG. 2 prior to actuation of the recliner mechanism actuator subassembly;

FIG. 4 is a plan view illustrating the subassembly of FIG. 3 subsequent to actuation of the recliner mechanism actuator subassembly;

FIG. 5 is a perspective, fragmentary view illustrating the subassembly of FIG. 3 prior to actuation of the recliner mechanism actuator subassembly;

FIG. 6 is a perspective view of the subassembly of FIG. 4 subsequent to actuation of the recliner mechanism actuator subassembly; and

FIG. 7 is a perspective view of various components of the subassembly of FIG. 2.

### DETAILED DESCRIPTION OF THE PREFERRED EMBODIMENT(S)

Detailed embodiments of the present invention are disclosed herein; however, it is to be understood that the disclosed embodiments are merely exemplary of the invention that may be embodied in various and alternative forms. The figures are not necessarily drawn to scale, some features may be exaggerated or minimized to show details of particular components. Therefore, specific structural and functional details disclosed herein are not to be interpreted as limiting, but merely as a representative basis for the claims and/or as a representative basis for teaching one skilled in the art to variously employ the present invention.

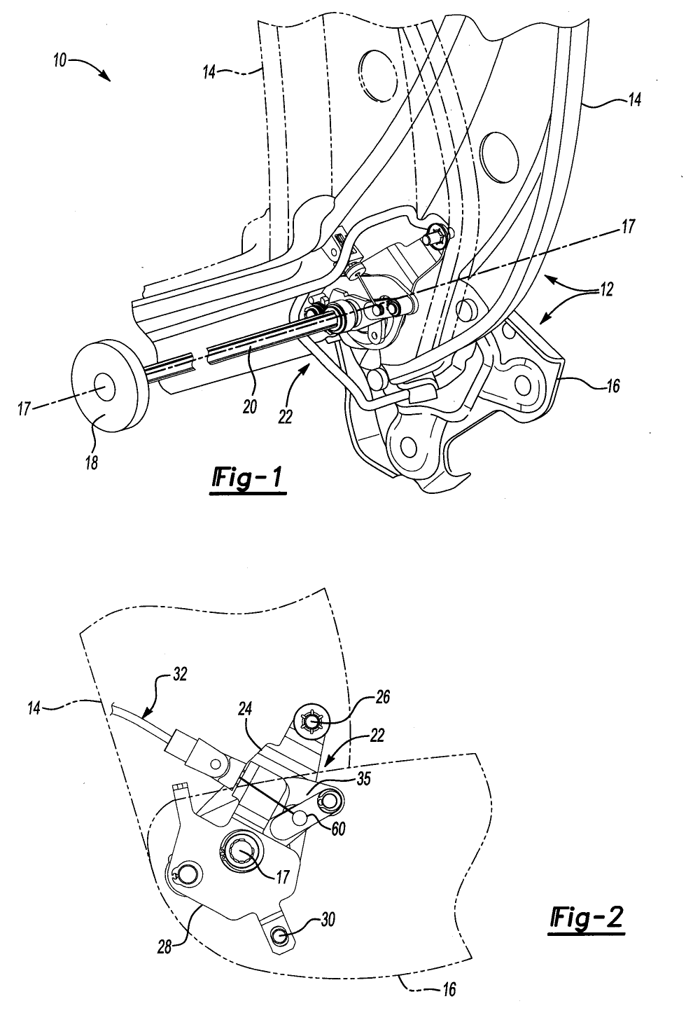

With reference to FIG. 1, portions of a vehicle seat assembly 10 are illustrated. Vehicle seat assembly 10 includes a vehicle seat body 12 having a seat back 14 and a seat bottom 16. Seat back 14 is configured to pivot with respect to seat bottom 16 to allow a user to recline seat back 14 to a desired angle. Vehicle seat body 12 further includes a recliner mechanism 18 that is configured to move between a locked position and an unlocked position. Recliner mechanism 18 inhibits seat back 14 from pivoting with respect to seat bottom 16 when recliner mechanism 18 is in the locked position and recliner mechanism 18 permits seat back 14 to pivot with respect to seat bottom 16 when recliner mechanism 18 is in the unlocked position. Recliner mechanism 18 includes recliner mechanism lever 20. In the illustrated embodiment, recliner mechanism lever 20 is an elongate bar disposed coaxially with a pivot axis 17 about which seat back 14 pivots. In the illustrated embodiment, recliner mechanism lever 20 has a non-circular cross section having an undulating perimeter to permit interlocking other components with recliner mechanism lever 20. As recliner mechanism lever 20 pivots about pivot axis 17, recliner mechanism 18 alternately locks and unlocks.

Vehicle seat assembly 10 may be used in any vehicle where it is desirable to perform an easy entry function including all automotive vehicles, and other types of vehicles including, but not limited to, rail driven vehicles, aircraft, water craft, and spacecraft. As used herein, the term “easy entry function” refers to the ability of a vehicle seat assembly or components thereof to move when actuated so as to allow a person greater clearance/access to an area of the vehicle located rearward of the vehicle seat assembly. In typical applications, a person may remotely trigger a recliner mechanism 18 to permit seat back 14 to pivot in a forward direction past a normal operating position (typically forward of perpendicular) to allow a user to enter or otherwise access an area disposed rearward of vehicle seat assembly 10. In some applications, vehicle seat assembly 10 is mounted on rails or otherwise slidably disposed on a floor surface of a vehicle to which it is attached. In such vehicles, actuation of the easy entry function may also result in the entire vehicle seat body 12 sliding forward during easy entry actuation.

In some instances, after the vehicle seat assembly's easy entry function has been actuated, it may be desirable to have seat back 14 return to substantially the same angular orientation with respect to seat bottom 16 that seat back 14 occupied immediately prior to actuation of the easy entry function. Such a feature could avoid the need for a user to readjust seat back 14 each time the easy entry function is actuated. To accomplish this, vehicle seat assembly 10 is equipped with recliner mechanism actuator subassembly 22 which is triggered when a person triggers vehicle seat assembly 10's easy entry function. As described below, recliner mechanism actuator subassembly 22 is configured to actuate recliner mechanism 18 and move it from the locked position to the unlocked position and is further configured to inhibit recliner mechanism 18 from returning to the locked position until seat back 14 pivots rearward to the position that it occupied immediately prior to actuation of the easy entry function. A description of the components of the recliner mechanism actuator subassembly 22 and its operation follows.

With respect to FIG. 2, a plan view of recliner mechanism actuator subassembly 22 is illustrated. A base member 24 is attached by base member fastener 26 to seat back 14. Base member 24 is a plate that is configured to pivot about pivot axis 17 together with seat back 14 as seat back 14 pivots about pivot axis 17. One of ordinary skill in the art will appreciate that base member 24 need not be a plate, but rather, may have any configuration appropriate to fit into the portion of seat back 14 where base member 24 is to be mounted. A housing 28 is connected to seat bottom 16 by housing fastener 30. Housing 28 is configured to mount cable assembly 32 which may be used to trigger the easy entry function of vehicle seat assembly 10. In the illustrated embodiment, cable assembly 32 is a Bowden type cable assembly including a sleeve and a cable 35 mounted within the sleeve and slidable therewith. A distant end of cable assembly 32 (not shown) may be attached to a switch, lever, or other actuator to permit remote actuation of the vehicle seat assembly's easy entry function. Such remote actuator is typically located along an upper, outboard portion of a vehicle seat back. In other embodiments, instead of a Bowden cable, other linkages may be employed including, but not limited to, rods, cables, and other types of linkages that are effective to trigger the vehicle seat assembly's easy entry function.

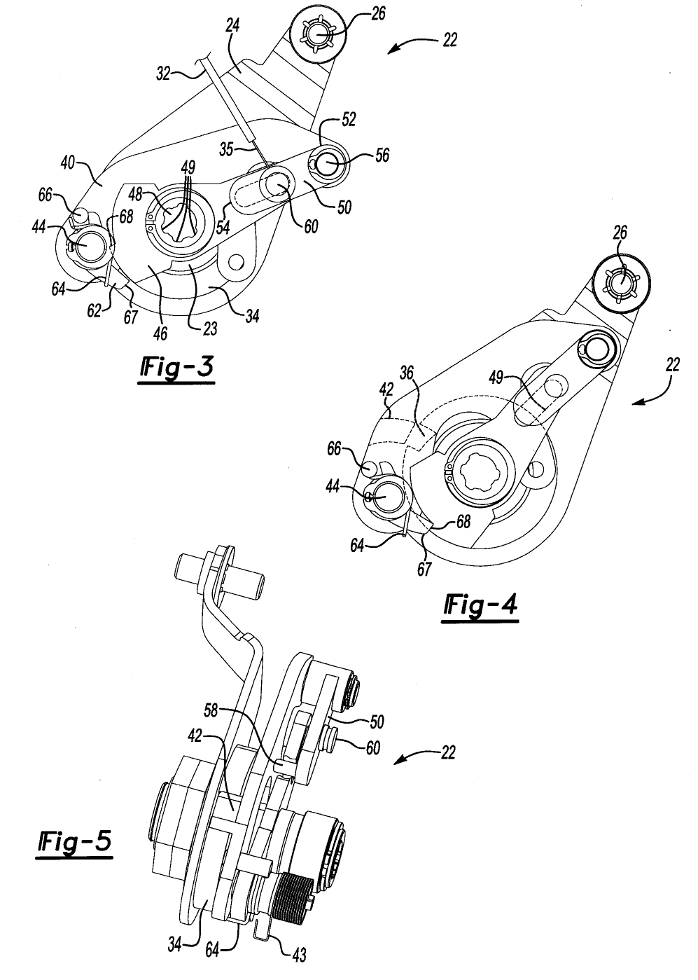

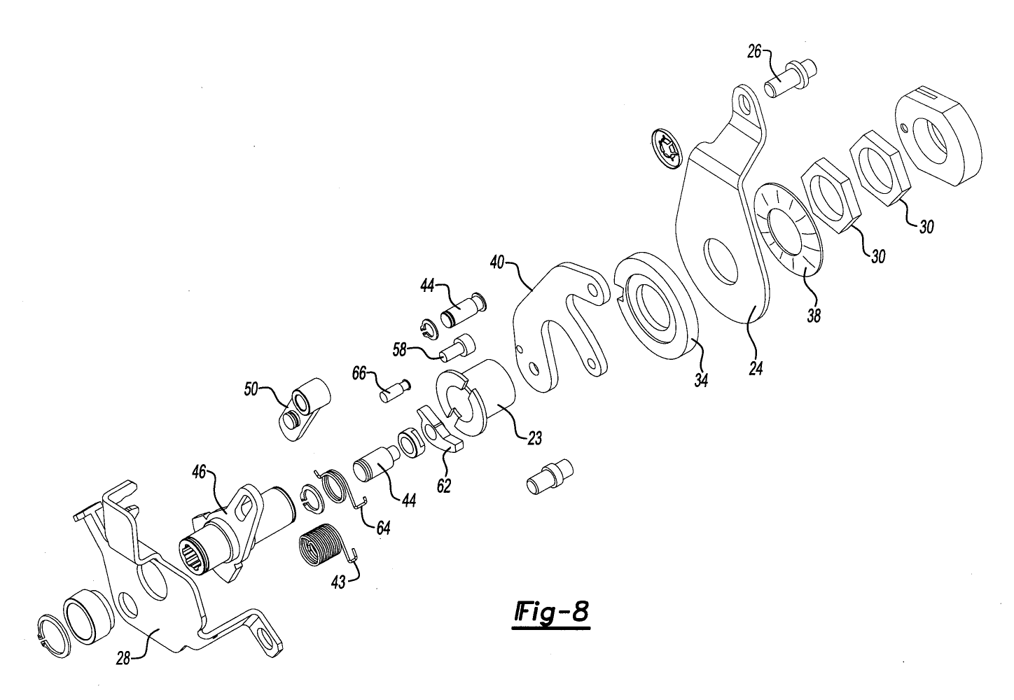

With respect to FIG. 3, recliner mechanism actuator subassembly 22 is illustrated without housing 28. A memory ring 34 is disposed adjacent to base member 34 and is configured to rotate about housing 23. Memory ring 34 includes a notch 36 defined in an outer surface of memory ring 34 (see FIGS. 4-7). Housing 23 receives recliner mechanism lever 20 and serves as a platform to support base member 24 and memory ring 34 as they pivot about pivot axis 17. In the illustrated embodiment, memory ring 34 is a ring. It should be understood that in other embodiments, memory ring 34 may not be a ring, but rather, may be configured as a ring section or may take any configuration that permits ring 34 to pivot about a circular axis. When pressed against base member 24, memory ring 34 can rotate about pivot axis 17 together with base member 24 as seat back 14 pivots. Plate spring 38 (see FIG. 7) is disposed adjacent base member 24 on a side of base member 24 opposite the side adjacent to memory ring 34. Plate spring 38 is held in place and compressed against base member 24 by a pair of fasteners 39 secured to housing 23. Plate spring 38 is compressed and exerts a force against base member 24 that results in a compressive force urging memory ring 34 against base member 24. The friction between the adjacent surfaces of base member 24 and memory ring 34 causes memory ring 34 to rotate together with base member 24 as base member 24 pivots together with seat back 14 about pivot axis 17.

A memory ring engagement member 40 is pivotally connected to housing 28 (see FIG. 1). Memory ring engagement member 40 includes a protrusion 42 (see FIG. 4) that is configured to engage with notch 36 of memory ring 34. Memory ring engagement member 40 is configured to pivot with respect to housing 28 about pivotal connector 44 between an engaged position and a disengaged position. When memory ring engagement member 40 is in the engaged position, protrusion 42 is disposed within notch 36. When memory ring engagement member 40 is disposed in the disengaged position, memory ring engagement member 40 has pivoted to a position where protrusion 42 is no longer engaged with notch 36. In FIG. 3, memory ring engagement member 40 is disposed in the engaged position.

When memory ring engagement member 40 is in the engaged position and protrusion 42 is engaged with notch 36, memory ring 34 is inhibited from rotating about pivot axis 17. Accordingly, as seat back 14 pivots about pivotal axis 17, and as base member 24 pivots with seat back 14, memory ring 34 remains substantially stationary and base member 24 pivots with respect to memory ring 34. In this manner, as a user of vehicle seat assembly 10 adjusts seat back 14 from one position to another without actuation of the easy entry function, memory ring 34 does not pivot and base member 24 pivots with respect to memory ring 34.

A recliner mechanism engagement member 46 is disposed adjacent memory ring engagement member 40 and is configured to engage recliner mechanism lever 20. Recliner mechanism engagement member 46 is configured to pivot about axis 17 between a closed position and an open position. When recliner mechanism engagement member 46 is in the closed position, recliner mechanism 18 is locked. When recliner mechanism engagement member 46 is in the open position, recliner mechanism 18 is unlocked. As recliner mechanism engagement member 46 rotates from the closed position to the open position, it exerts a torque force on recliner mechanism 20 which transmits the torque to recliner mechanism 18. Recliner mechanism 18 is biased by a spring (referred to herein alternatively as the recliner mechanism spring and the third biasing member). When the torque exerted by recliner mechanism engagement member 46 overcomes the biasing force of the recliner mechanism spring, the recliner mechanism moves from the locked position to the unlocked position.

As illustrated in FIG. 3, recliner mechanism engagement member 46 has an opening 48 extending therethrough. A perimeter of opening 48 includes a plurality of depressions 50. Depressions 50 are contoured and disposed about the perimeter of opening 48 in a configuration such that each depression registers with a corresponding elevation in the perimeter surface of recliner mechanism lever 20. This configuration permits recliner mechanism engagement member 46 to torque recliner mechanism lever 20 as recliner mechanism engagement member 46 moves from the closed position to the open position. In other embodiments, different geometric configurations may be employed to permit recliner mechanism engagement member 46 to engage recliner mechanism lever 20. Recliner mechanism engagement member 46 includes a slot in a surface of recliner mechanism engagement member 46 and extending therethrough. In other embodiments, slot 49 may not extend entirely through recliner mechanism engagement member 46.

A memory ring engagement member spring 43 (also referred to herein as the second biasing member) (see FIG. 5) is disposed proximate pivotal connector 44. Memory ring engagement member spring 43 biases memory ring engagement member 40 toward the engaged position.

A connecting rod 50 connects recliner mechanism engagement member 46 with memory ring engagement member 40. Connecting rod 50 has a first end 52 and a second end 54. Connecting rod 50 is pivotally connected to memory ring engagement member 40 proximate first end 52 by pivotal connector 56. Connecting rod 50 includes a slot engaging protrusion 58 configured to fit within slot 49 and to pivot and slide with respect to slot 49. Configured in this manner, recliner mechanism engagement member 46 may move between the closed position and open position without disturbing the memory ring engagement member. This may occur when a comfort adjustment actuator (not shown) is actuated to allow an occupant of vehicle seat assembly 10 to adjust the angle of recline of seat back 14. During such an adjustment, (non-easy entry adjustment) as the angle of seat back 14 is adjusted, base member 24 pivots together with seat back 14 but memory ring 34 remains stationary because of the engagement between notch 36 and protrusion 42. This relative motion between memory ring 34 and base member 24 permits memory ring 34 to serve as an indicator of the current recline position of seat back 14.

Connecting rod 50 includes a linkage attachment point 60 for receiving cable 35. As best seen in FIG. 5, linkage attachment point 60 comprises a substantially cylindrical protrusion defining a groove to permit engagement with cable 35. In other embodiments, any configuration effective to engage with cable 35 may be employed. When cable 35 is pulled, such as when the seat occupant actuates the easy entry function, a force is exerted on connecting rod 50. The force acting on connecting rod 50 is transmitted to both recliner mechanism engagement member 46 and memory ring engagement member 40. The recliner mechanism spring has a higher spring constant than memory ring engagement member spring 43. Accordingly, in response to the force exerted on connecting rod 50 by cable 35, memory ring engagement member 40 begins to pivot from the engaged position to the disengaged position. In some embodiments, memory ring engagement member 40 will reach the disengaged position before recliner mechanism engagement member 46 begins to move under the force exerted by cable 35. In other embodiments, recliner mechanism engagement member 46 will begin to move from the closed position to the open position before memory ring engagement member 40 reaches the disengaged position. In such embodiments, recliner mechanism engagement member 46 will either reach the open position subsequent to or substantially simultaneously with memory ring engagement member 40 reaching the disengaged position.

Once memory ring engagement member 40 is in the disengaged position and recliner mechanism engagement member 46 is in the open position, recliner mechanism 18 is unlocked. Seat back 14 and base member 24 are free to pivot and memory ring 34 is free to pivot together with base member 24 under the urging of plate spring 38 (also referred to herein as the first biasing member). The position of memory ring 34 with respect to base member 24 remains substantially constant as base member 24 pivots together with seat back 14.

As memory ring 34 rotates together with base member 24, notch 36 comes out of alignment with protrusion 42. As seat back 14 continues to pivot forward towards the easy entry position, notch 36 moves further and further out of alignment with protrusion 42. While notch 36 and protrusion 42 are out of alignment, protrusion 42 slides along the perimeter of memory ring 34 and memory ring engagement member 40 is thereby obstructed from returning to the engaged position. After completion of the easy entry function, a user may pivot seat back 14 in a rearward direction to return it to an operational position. As seat back 14 begins to pivot rearward, base member 24 and memory ring 34 also begin to pivot. As memory ring 34 pivots rearward, notch 36 begins to move back towards protrusion 42. When seat back 14 has pivoted rearward to the angular orientation that it had been disposed in immediately prior to actuation of the easy entry function, notch 36 aligns with protrusion 42 and memory ring engagement member 40 returns to the engaged position under the urging of memory ring engagement member spring 43.

A blocking member 62 (best seen in FIGS. 4-6) is disposed proximate memory ring engagement member 40 and is pivotally connected at pivotal connector 44. Blocking member 62 is configured to pivot between a blocking position and a non-blocking position. In FIG. 3, blocking member 62 is illustrated in the non-blocking position and in FIG. 4, blocking member 62 is illustrated in the blocking position. A blocking member spring 64 biases blocking member 62 towards the blocking position. Blocking member 62 includes an engagement surface 67 for engaging recliner mechanism engagement member 62.

A retaining member 66 is attached to memory ring engagement member 40 and is disposed proximate blocking member 64. When memory ring engagement 40 is disposed in the engaged position, retaining member 66 engages blocking member 62 and retains blocking member 62 in the non-blocking position. When memory ring engagement member 40 moves to the disengaged position (see FIG. 4), retaining member 66 disengages from blocking member 62 and blocking member 62 moves to the blocking position.

Recliner mechanism engagement member 46 includes a ledge 68 (see FIG. 4) proximate blocking member 62. As illustrated in FIG. 3, prior to actuation of the recliner mechanism actuator subassembly 22, ledge 68 is spaced apart from engagement surface 67. Once recliner mechanism engagement member 46 moves to the open position (see FIG. 4), ledge 68 is disposed in close proximity to engagement surface 67. While memory ring engagement member 40 remains in the engaged position, blocking member 62 is retained in the non-blocking position, and recliner mechanism engagement member 46 is free to move between the closed position and open position without obstruction by blocking member 62. In this manner, a seat occupant may adjust the angle of recline of seat back 14 using an actuator other than recliner mechanism actuator subassembly 22 which causes recliner mechanism engagement member 46 to pivot between the closed position and the open position.

In FIG. 4, recliner mechanism actuator subassembly 22 is illustrated in the actuated state, immediately prior to rotation of seat back 14. Memory ring engagement member 40 is illustrated in the disengaged position with protrusion 42 disengaged from notch 36. Retaining member 66 has disengaged from blocking member 62 and blocking member 62 has moved to the blocking position under the urging of blocking member spring 64. Recliner mechanism engagement member 46 has pivoted to the open position and is retained in the open position by engagement between ledge 68 and engagement surface 67. So long as recliner mechanism engagement member 46 is retained in the open position, recliner mechanism 18 remains unlocked and seat back 14 remains free to pivot about pivot axis 17.

When seat back 14 returns to the angular orientation that it occupied immediately prior to actuation of the easy entry function, notch 36 comes into alignment with protrusion 42. This alignment permits memory ring engagement member 40 to return to the engaged position. As memory ring engagement member 40 returns to the engaged position, retaining member 66 engages blocking member 62 and moves blocking member 62 back to the non-blocking position. When blocking member 62 has returned to the non-blocking position, engagement surface 67 comes out of engagement with ledge 68 and recliner mechanism engagement member 46 returns to the closed position under the urging of the recliner mechanism spring, allowing recliner mechanism 18 to return to the locked position. In this manner, seat back 14 “remembers” its angular orientation with respect to seat bottom 16 when the easy entry function is actuated, thus allowing seat back 14 to return to, and lock in place at substantially the same angular orientation with respect to seat bottom 16 that it had occupied immediately prior to actuation of the easy entry function.

With respect to FIG. 5, a perspective view of recliner mechanism actuator subassembly 22 is presented. Recliner mechanism actuator subassembly 22 is illustrated in a non-actuated state. In this view, engagement between notch 36 and protrusion 42 is clearly illustrated. Additionally, a portion of memory ring engagement member 40 has been fragmented away to reveal slot engaging protrusion 58 engaging slot 49.

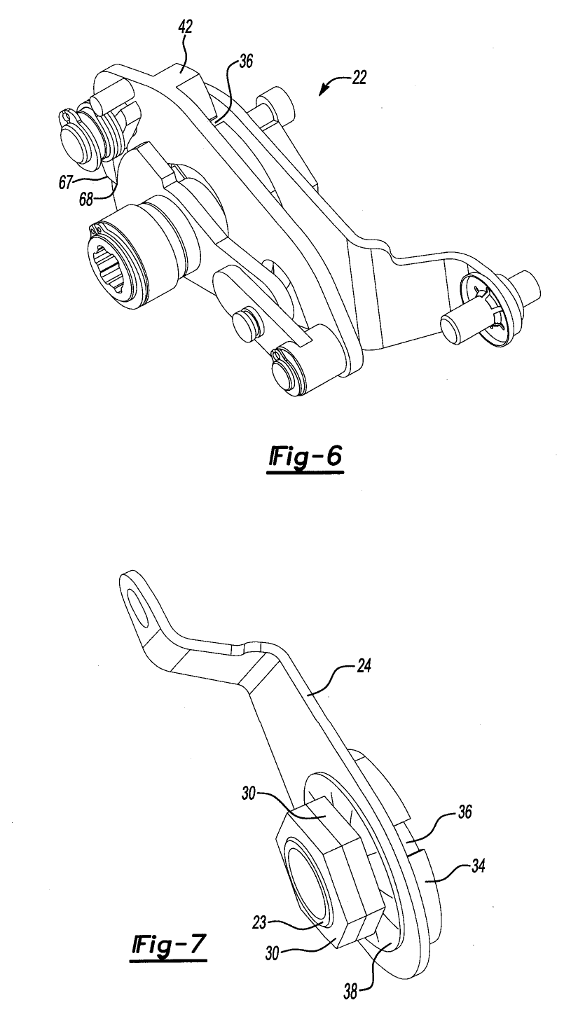

With respect to FIG. 6, a perspective view of recliner mechanism actuator subassembly 22 is illustrated from a different perspective. In this view, recliner mechanism actuator subassembly 22 is illustrated in an actuated state. The disengagement of protrusion 42 from notch 36 and the engagement between ledge 68 and engagement surface 67 is clearly visible.

With respect to FIG. 7, a perspective view of base member 24 and memory ring 34 is presented. Fasteners 30 are attached to housing 23 and compress plate spring 38 against base member 24. The compression of plate spring 38 drives base member 24 and memory ring 34 against one another such that, in the absence of memory ring engagement member 40, friction will cause memory ring 34 and base member 24 to pivot together about pivot axis 17 as a single unit.

With respect to FIG. 8, an exploded view of recliner mechanism actuator subassembly 22 is illustrated. The individual components of recliner mechanism actuator subassembly 22 are configured as they would be when recliner mechanism actuator subassembly 22 is in the closed position.

The components of recliner mechanism actuator subassembly 22 may be made from materials comprising metals, plastics, and combinations thereof. While Applicant's disclosure indicates that recliner mechanism actuator subassembly 22 is disposed on an inboard portion of seat back 14, one of ordinary skill in the art should appreciate that recliner mechanism actuator subassembly 22 may also be disposed along an outboard portion of seat back 14.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A vehicle seat assembly capable of performing an easy entry function, the vehicle seat assembly comprising:
a seat body having a seat bottom, a seat back configured to pivot with respect to the seat bottom about a pivot axis, and a recliner mechanism configured to inhibit the seat back from pivoting when the recliner mechanism is locked and to permit the seat back to pivot when the recliner mechanism unlocked; and
a recliner mechanism actuator subassembly disposed proximate the seat body, the recliner mechanism actuator subassembly having:
a base member connected to the seat back and configured to pivot together with the seat back about the pivot axis,
a memory ring having an outer surface and a notch defined in the outer surface, the memory ring being disposed proximate the base member and configured to rotate about the pivot axis, and
a memory ring engagement member connected to the seat bottom proximate the memory ring and having a protrusion configured to engage the notch, the memory ring engagement member being configured to move between an engaged position wherein the protrusion engages the notch and a disengaged position wherein the protrusion is disengaged from the notch,
wherein the memory ring engagement member inhibits the memory ring from rotating about the pivot axis when in the engaged position such that the base member rotates with respect to the memory ring as the base member pivots together with the seat back,
wherein the memory ring rotates together with the base member as the seat back pivots when the memory ring engagement member is in the disengaged position,
wherein the memory ring engagement member is inhibited from returning to the engaged position until the notch is substantially aligned with the protrusion, and
wherein the recliner mechanism remains unlocked while the memory ring engagement member is in the disengaged position.

2. The vehicle seat assembly of claim 1 wherein the memory ring engagement member pivots between the engaged position and the disengaged position.

3. The vehicle seat assembly of claim 1 wherein the recliner mechanism actuator subassembly further includes a first biasing member configured to urge the memory ring and the base member against one another such that friction between the base member and the memory ring causes the memory ring to pivot together with the base member when the seat back pivots while the memory ring engagement member is in the disengaged position.

4. The vehicle seat assembly of claim 3 wherein the first biasing member is a spring.

5. The vehicle seat assembly of claim 4 wherein the first biasing member is a plate spring.

6. A vehicle seat assembly capable of performing an easy entry function, the vehicle seat assembly comprising:
a seat body having a seat bottom, a seat back configured to pivot with respect to the seat bottom about a pivot axis, and a recliner mechanism configured to inhibit the seat back from pivoting when the recliner mechanism is locked and to permit the seat back to pivot when the recliner mechanism unlocked; and
a recliner mechanism actuator subassembly disposed proximate the seat body, the recliner mechanism actuator subassembly having:
a base member connected to the seat back and configured to pivot together with the seat back about the pivot axis,
a memory ring having an outer surface and a notch defined in the outer surface, the memory ring being disposed proximate the base member and configured to rotate about the pivot axis,
a memory ring engagement member connected to the seat bottom proximate the memory ring and having a protrusion configured to engage the notch, the memory ring engagement member being configured to move between an engaged position wherein the protrusion engages the notch and a disengaged position wherein the protrusion is disengaged from the notch, and
a recliner mechanism engagement member engaged with the recliner mechanism and configured to move between a closed position and an open position, the recliner mechanism engagement member being configured to move the recliner mechanism from the locked position to the unlocked position when the recliner mechanism engagement member moves from the closed position to the open position and wherein the recliner mechanism moves from the unlocked position to the locked position when the recliner mechanism engagement member moves from the open position to the closed position,
wherein the memory ring engagement member inhibits the memory ring from rotating about the pivot axis when in the engaged position such that the base member rotates with respect to the memory ring as the base member pivots together with the seat back,
wherein the memory ring rotates together with the base member as the seat back pivots when the memory ring engagement member is in the disengaged position,
wherein the memory ring engagement member is inhibited from returning to the engaged position until the notch is substantially aligned with the protrusion, and
wherein the memory ring engagement member is configured to inhibit the recliner mechanism engagement member from moving from the open position to the closed position while the memory ring engagement member is in the disengaged position.

7. The vehicle seat assembly of claim 6 wherein the recliner mechanism engagement member pivots about the pivot axis between the open position and the closed position.

8. The vehicle seat assembly of claim 6 wherein the recliner mechanism actuator subassembly further comprises a connecting rod having a first end and a second end, the connecting rod being pivotally connected at the first end to the memory ring engagement member and being pivotally connected at the second end to recliner mechanism engagement member.

9. The vehicle seat assembly of claim 8 wherein the recliner mechanism engagement member includes a slot extending along a length of the recliner mechanism engagement member and wherein the connecting rod includes a pin disposed within the slot and configured to slide along the slot.

10. The vehicle seat assembly of claim 8 wherein the connecting rod includes an attachment member adapted to receive a linkage to facilitate remote actuation of the recliner mechanism actuator subassembly.

11. The vehicle seat assembly of claim 8 further including a second biasing member biasing the memory ring engagement member towards the engaged position, and a third biasing member biasing the recliner mechanism engagement member towards the closed position.

12. The vehicle seat assembly of claim 11 wherein the second and third biasing members are springs.

13. The vehicle seat assembly of claim 11 wherein the third biasing member has a higher spring constant than the second biasing member and wherein an actuating force acting on the connecting rod causes the memory ring engagement member to move from the engaged position to the disengaged position before the recliner mechanism engagement member moves to the open position.

14. The vehicle seat assembly of claim 13 wherein the third biasing member has a sufficiently higher spring constant than the second biasing member such that an actuating force acting on the connecting rod causes the memory ring engagement member to move from the engaged position to the disengaged position before the recliner mechanism engagement member moves from the closed position.

15. The vehicle seat assembly of claim 6 wherein the memory ring engagement member pivots between the engaged position and the disengaged position.

16. The vehicle seat assembly of claim 6 wherein the recliner mechanism actuator subassembly further includes a first biasing member configured to urge the memory ring and the base member against one another such that friction between the base member and the memory ring causes the memory ring to pivot together with the base member when the seat back pivots while the memory ring engagement member is in the disengaged position.

17. The vehicle seat assembly of claim 16 wherein the first biasing member is a spring.

18. The vehicle seat assembly of claim 17 wherein the first biasing member is a plate spring.

19. A vehicle seat assembly capable of performing an easy entry function, the vehicle seat assembly comprising:
a seat body having a seat bottom, a seat back configured to pivot with respect to the seat bottom about a pivot axis, and a recliner mechanism configured to inhibit the seat back from pivoting when the recliner mechanism is locked and to permit the seat back to pivot when the recliner mechanism unlocked; and
a recliner mechanism actuator subassembly disposed proximate the seat body, the recliner mechanism actuator subassembly having:
a base member connected to the seat back and configured to pivot together with the seat back about the pivot axis,
a memory ring having an outer surface and a notch defined in the outer surface, the memory ring being disposed proximate the base member and configured to rotate about the pivot axis,
a memory ring engagement member connected to the seat bottom proximate the memory ring and having a protrusion configured to engage the notch, the memory ring engagement member being configured to move between an engaged position wherein the protrusion engages the notch and a disengaged position wherein the protrusion is disengaged from the notch,
a recliner mechanism engagement member engaged with the recliner mechanism and configured to move between a closed position and an open position, the recliner mechanism engagement member being configured to move the recliner mechanism from the locked position to the unlocked position when the recliner mechanism engagement member moves from the closed position to the open position and wherein the recliner mechanism moves from the unlocked position to the locked position when the recliner mechanism engagement member moves from the open position to the closed position, and
a blocking member connected to the memory ring engagement member, the blocking member configured to move between a blocking position wherein the blocking member inhibits the recliner mechanism engagement member from moving from the open position to the closed position and a non-blocking position wherein the blocking member does not inhibit the recliner mechanism engagement member from moving from the open position to the closed position, the blocking member being biased towards the blocking position,
wherein the memory ring engagement member inhibits the memory ring from rotating about the pivot axis when in the engaged position such that the base member rotates with respect to the memory ring as the base member pivots together with the seat back,
wherein the memory ring rotates together with the base member as the seat back pivots when the memory ring engagement member is in the disengaged position,
wherein the memory ring engagement member is inhibited from returning to the engaged position until the notch is substantially aligned with the protrusion, and
wherein the memory ring engagement member is configured to move the blocking member from the blocking position to the non-blocking position when the memory ring engagement member moves from the disengaged position to the engaged position.

20. The vehicle seat assembly of claim 19 wherein the memory ring engagement member includes a retaining member configured to engage the blocking member, wherein the retaining member retains the blocking member in the non-blocking position when the memory ring engagement member is in the engaged position, and wherein the retaining member permits the blocking member to move to the blocking position when the memory ring engagement member is in the disengaged position.
